(19) United States
(12) Patent Application Publication
(10) Pub. No.: US 2016/0158759 A1
(43) Pub. Date: Jun. 9, 2016

(54) RECOVERY ASSEMBLY FOR CRYOPRESERVATION APPLICATIONS

(71) Applicant: SANOFI-AVENTIS DEUTSCHLAND GMBH, Frankfurt am Main (DE)

(72) Inventors: Volker Derdau, Frankfurt am Main (DE); Andreas Wolf, Frankfurt am Main (DE); Petra Arndt, Frankfurt am Main (DE); Verena Siefke-Henzler, Frankfurt am Main (DE); Christoph Dette, Frankfurt am Main (DE); Ulrike Milbert, Frankfurt am Main (DE)

(21) Appl. No.: 14/906,119

(22) PCT Filed: Aug. 5, 2014
(86) PCT No.: PCT/EP2014/066791

§ 371 Date: Jan. 19, 2016

(30) Foreign Application Priority Data
Aug. 8, 2013 (EP) 13179684.9

(51) Int. Cl. B01L 7/00; B01L 9/00

(52) U.S. Cl. CPC B01L 7/50; B01L 9/00

(57) ABSTRACT

A recovery assembly for a cryopreservation device is presented having a support for mounting the recovery assembly to an access opening of a container to be at least partially filled with the cooling agent, and at least one flow channel to form at least one protective gas stream to reduce escapement of the cooling agent from the container.

### CROSS REFERENCE TO RELATED APPLICATIONS

The present application is a U.S. National Phase Application pursuant to 35 U.S.C. §371 of International Application No. PCT/EP2014/066791 filed Aug. 5, 2014, which claims priority to European Patent Application No. 13179684.9 filed Aug. 8, 2013. The entire disclosure contents of these applications are herewith incorporated by reference into the present application.

### TECHNICAL FIELD

The present invention relates to a recovery assembly and to a cryopreservation device for reducing consumption and losses of a cooling agent usable for cryopreservation of cryosamples. The invention therefore relates to an assembly and to a respective device for treating or examining of cryosamples and well as for inserting or extracting of cryosamples to and from a sample container.

### BACKGROUND

Freezing of samples of e.g. biological material while maintaining the vitality of the sample material at temperatures of liquid nitrogen, i.e. −196° Celsius, is widely known in the areas of biology, pharmacology, medicine and biotechnology. Samples to be frozen and being designated as cryosamples are customarily stored and transferred in sample containers. Such sample containers, also denoted as cryotanks are typically filled with liquid nitrogen. Furthermore, such containers are thermally insulated and may resemble or comprise a so called Dewar vessel.

Insertion and extraction or removal of samples into and from such containers is sometimes critical. Especially when removing or extracting a sample from a filled sample container, a non-negligible amount of nitrogen may be spilled or may otherwise leave the container in a rather uncontrolled way. It is not only, that the cooling agent is spilled or wasted but that the surrounding air becomes enriched with gaseous nitrogen. Hence, there may further evolve a certain risk of health or of suffocating.

Document US 2006/0156753 A1 relates to the aspect of preventing a contact of the surrounding and relatively moist air when handling samples and/or sample containers. There, prevention of ice formation on the sample containers and/or samples and their germination is prevented in various ways. It is suggested to provide a protective container that receives the sample and/or the entire sample container during the handling. Moreover, a climate control equipment is provided which is connected to the protective container in order to dry and cool the ambient gas present in the protective container and/or replace it with the protective gas. Hence, an artificial atmosphere is preferably created in the protective container to prevent ice formation on the sample and/or sample container.

Complexity of the technical equipment to provide such a protective atmosphere is rather high as well as cost intensive.

It is therefore an object of the present invention to provide an improved cryopreservation device together with a recovery assembly for reducing and preventing uncontrolled escapement of the cooling agent. Moreover, consumption and waste of the cooling agent should be kept on a low or at least moderate level. It is a further aim to enhance operational safety of such devices and to protect operative staff against uncontrolled and vast exposure to the cooling agent, e.g. liquid nitrogen.

### SUMMARY

In order to provide a solution to the above mentioned task a recovery assembly for a cryopreservation device is provided. The recovery assembly is particularly adapted and operable to recover a cooling agent of the cryopreservation device. The recovery assembly comprises a support for mounting the recovery assembly to an access opening of a container, which is to be at least partially filled with the cooling agent. The container is preferably designed as a sample container for cryopreservation purpose. Hence, the container may comprise a Dewar vessel being open to the top in order to allow permanent evaporation cooling of the liquid cooling agent disposed therein. The container is particularly implemented as a cryopreservation container. The recovery assembly is adapted to be mounted to the upper access opening of the container for recovery of the cooling agent, especially when extracting a sample from the container.

The recovery assembly further comprises or defines at least one flow channel to form at least one protective gas stream to reduce escapement of the cooling agent from the container. Hence, the recovery assembly does not only provide a protective atmosphere but is operable to produce a protective gas stream counteracting evaporation and/or escapement of the cooling agent from the container in general. The at least one flow channel in combination with the support is particularly operable and beneficial for extracting procedures during which a sample disposed in the container and in the cooling agent is extracted therefrom and is outwardly displaced through the access opening. By making use of at least one flow channel, a mechanical slaving effect may be exploited, by way of which cooling agent enriched air is to be mechanically treated, e.g. accelerated, to release and to recover the cooling agent. In general, the recovery assembly implements a hydro- or fluiddynamic approach to recover an amount of the cooling agent that would otherwise escape from the container towards the environment. In this way, the consumption and waste of the cooling agent can be reduced.

The support to be mounted to the access opening of the container is preferably mechanically engageable with said container. In particular, the support and the access opening comprise mutually engaging fixing means, e.g. in form of positive engaging locking means, such like a bayonet cap, a screw connection or mutually engaging bolts and recesses. Preferably, support and access opening are releasably engageable. This way, the recovery assembly may be arbitrarily used with a large variety of containers, in particular with sample containers. While cryosamples are stored in a specific container, the recovery assembly may be disassembled and may be used with other sample containers at least for extracting samples therefrom. Therefore, a single recovery assembly may be used with several sample containers.

In a preferred embodiment the recovery assembly comprises at least one cone-shaped funnel portion converging towards the support. Hence, the recovery assembly may comprise a funnel of e.g. circular-shape or circular cross section extending in a diverging way from the support. By means of the cone-shaped funnel portion, excess cooling agent, which in the course of extraction of a cryosample may drip or rinse down from a sample or from a respective specimen holder can be collected and fed back into the container in a controlled way.

The cone-shaped funnel portion provides a well defined rinsing and backflow of excess cooling agent. The backflow of the cooling agent is further supported by the at least one flow channel and by the protective gas stream. In particular, the protective gas stream may circulate around the cone-shaped funnel portion and may follow or define a helical structure or trajectory. This way, drops or portions of the cooling agent which may drip down from an extracted cryosample may be driven by the protective gas stream to hit the cone-shaped funnel portion so that the excess cooling agent may rinse down the funnel portion for re-entering the sample container.

In a further preferred embodiment the recovery assembly also comprises a filter penetrable by the cooling agent and being arranged downstream of said funnel portion. By means of a filter, particles or particulate substances may be filtered and may therefore be hindered to enter the container. This way, a contamination of the sample container and the cooling agent disposed therein can be effectively prevented.

According to a further embodiment the recovery assembly also comprises an extraction assembly at least for extracting a specimen, e.g. a cryosample from the container through the access opening. Typically, the support of the recovery assembly as well as the funnel portion comprise a free inner diameter which is at least as large as the inner diameter of the access opening of the sample container. This way, the size of the access opening is not restricted by the recovery assembly. The extraction assembly of the recovery assembly is particularly adapted to grip and to raise at least one specimen out of the cooling agent and upwards through the access opening of the sample container.

The recovery assembly and the extraction assembly may either be releasably coupled or may be integrally formed. With a releasable coupling of recovery assembly and extraction assembly, the recovery assembly may be used with other, e.g. stationary and immobile extraction assemblies, which may for instance be mounted to a ceiling of a room. With an integrated arrangement of recovery assembly and extraction assembly, mounting of the recovery assembly on the access opening of the sample container immediately provides an appropriate position of the extraction assembly relative to the sample container. This way, a separate positioning and configuration of the extraction assembly is not required.

In a further embodiment, wherein the extraction assembly is attached to the recovery assembly, the extraction assembly comprises at least one pillar or a similar support structure extending through the recovery assembly's funnel portion to support a pulling device located above an upper end of the funnel portion. The pulling device may comprise a flexible strap or a chain, by means of which the at least one specimen located in the sample container can be gripped and lifted out of the sample container.

Here, the specimen and the extraction assembly may comprise mutually engaging fastening means, such like hooks, by way of which the specimen can be lifted and raised out of the cooling agent. Since the pulling device is located above an upper end of the funnel portion the at least one specimen can be lifted to a level above said upper end, where it can be taken and laterally displaced, e.g. after excess liquid agent has been collected in the recovery assembly underneath. Typically, the pulling device may comprise a pulley or deflection roller so that an upwardly directed pulling of the specimen is achievable by tearing the flexible strap or a chain downward or to the side.

According to another embodiment the extraction assembly comprises a further support extending from an upper end of the funnel portion obliquely opposite to a slanted inner sidewall portion of the funnel portion for supporting a specimen holder in an inclined orientation above an orifice of the support and/or above the access opening of the sample container.

By means of the slanted or tilted inner sidewall portion of the funnel portion the specimen holder or the specimen itself can be kept in an inclined orientation, thereby supporting a rinsing and dripping down of excess liquid cooling agent when lifting the specimen holder out of the cooling agent. The further support may be removably or pivotally arranged on the funnel portion or at an upper end thereof. The further support extends at least partially radially inwardly so that the specimen or specimen holder may also abut and may also be supported by the obliquely opposite slanted inner sidewall portion of the funnel portion.

By means of the further support and the oppositely located inner sidewall portion, the specimen and/or the respective specimen holder can be kept in a well defined inclined position above the orifice of the support. In this way, the recovery assembly is particularly suitable for conducting of a two-step extraction process. In a first process step, a specimen may be simply lifted from the sample container and out of the liquid agent contained therein until a raised position or a raised level has been reached, in which the specimen has completely left the cooling agent. Thereafter, by making use of the slanted inner sidewall portion of the funnel portion and by making use of the radially inwardly extending further support, the specimen can be kept in a raised and slanted orientation especially for recovering of excess liquid agent that may be pulled out of the sample container together with the specimen and/or specimen holder.

In a further embodiment the flow channel to form the at least protective gas stream is in fluid communication with an inside facing wall of the funnel portion. This way, the protective gas stream to be generated by the flow channel may therefore propagate along the inside facing wall of the funnel portion. This way, the efficiency of cooling agent recovery may be further enhanced. The kinetic energy and the angular and/or linear momentum of the protective gas stream are suitable and adapted for transportation of fugitive and escaping portions or components of the cooling agent. In this way evaporated cooling agent typically emanating through the access opening of the container in an upward direction can be directed towards the inner sidewall of the funnel portion where it may condense and return into the container.

In a further preferred aspect, the flow channel extends in tangential direction around the circumference of a converged lower end of the funnel portion to generate a cyclone-like protective gas stream inside or along the funnel portion. Preferably, the flow channel is arranged downstream of the filter of the recovery assembly. Furthermore, the flow channel may be arranged in direct proximity or may even be integrated into the support of the recovery assembly. Preferably, the flow channel is arranged axially between the filter and the support so that the protective gas stream to flow or to stream along the inside of the funnel portion does not substantially enter the access opening of the sample container. By having the flow channel arranged above the support, ingress of protective gas into the interior of the sample container can be effectively prevented.

In another embodiment the at least one flow channel extends around an upper, hence around a distal end of the funnel portion. In this context, the distal end of the recovery assembly denotes that end portion that is furthest away from the sample container while a proximal and oppositely arranged end is located closest to the sample container and may therefore comprise the support for engaging with the same. Further in this context, the axial direction denotes the axis of symmetry of the funnel portion. Typically, the specimen or cryosamples located or stored in the sample container are to be raised or lifted from the interior of the sample container in axial direction.

By having arranged the at least one flow channel at the upper distal end of the funnel portion, another or an alternative protective gas stream can be generated, which may act as a gas- or air curtain, by way of which ingress of surrounding air into the funnel portion and/or into the sample container can be effectively prevented or at least counteracted. The flow channel provided at an upper distal end may be operable to generate another cyclone-like stream of protective gas or may be operable to generate a substantially axially extending or axially propagating protective gas stream.

According to a further preferred embodiment the at least one flow channel comprises at least one slit-like outlet extending in distal direction or extending radially inwardly for generating a substantially axially directed protective gas stream. The slit-like outlet is preferably of annular shape and may therefore surround the entire circumference of the upper or distal end of the funnel portion. This way, an axially extending protective gas stream, e.g. acting as an air curtain can be effectively provided.

In a further embodiment, another, hence a second flow channel is provided, preferably at the upper end of the funnel portion. The second flow channel is particularly operably to generate a respective second protective gas stream propagating and extending in a direction opposite to the direction of flow of the first protective gas stream. By means of the two counter-directed protective gas streams ingress of surrounding air into the funnel portion as well as diffusion, escapement or leakage of evaporated cooling agent from the recovery assembly can be effectively prevented or hindered. The two counter-propagating protective gas streams are radially separated. Here, the second flow channel completely encloses the first flow channel to generate respective nested protective gas streams.

Preferably, the radially inwardly located gas stream propagates downwards whereas the radially outwardly located gas stream propagates in the opposite direction, hence upwardly. This way, evaporated cooling agent or an aerosol enriched with the cooling agent can be sucked and directed axially downwardly to improve recovery of the cooling agent.

In a further preferred embodiment, the first flow channel is in flow communication with a suction blower whereas the second flow channel is in flow communication with a warm air blower. Preferably, the second flow channel is arranged radially outwardly and provides comparatively warm or hot air to generate a temperature barrier for the cooling agent. Additionally, the first flow channel operably connected with the suction blower is adapted to suck comparatively cold air, which may support condensation of evaporated cooling agent in or close to a region above the access opening of the sample container.

In a further but independent aspect also a cryopreservation device is provided which is adapted to store at least one specimen, in particular a cryosample. The cryopreservation device comprises a container to accommodate a liquid cooling agent, such as liquid nitrogen. Said container further comprises an access opening at a distal upper end. Moreover, the cryopreservation device comprises and is equipped with a recovery assembly as described above. Here, the recovery assembly is mounted on the access opening via its support or may be simply operable to be mounted to said access opening.

In a further and preferred embodiment, the recovery assembly is removably mounted on the access opening, preferably in a releasable and reconfigurable way. This allows to arbitrarily couple the recovery assembly with a variety of sample containers whenever specimens or cryosamples have to be put into or taken from the container.

It will be further apparent to those skilled in the pertinent art that various modifications and variations can be made to the present invention without departing from the spirit and scope of the invention. Further, it is to be noted, that any reference signs used in the appended claims are not to be construed as limiting the scope of the present invention.

### BRIEF DESCRIPTION OF THE DRAWINGS

In the following, preferred embodiments of the invention will be described in greater detail by making reference to the drawings, in which:

FIG. 1 schematically illustrates a recovery assembly mounted on top of a sample container according to a first embodiment,

FIG. 2 is illustrative of another embodiment of the recovery assembly,

FIG. 3 schematically illustrates a recovery assembly comprising two counter-directed flow channels,

FIG. 4 schematically shows a cross-section through the funnel-shaped recovery assembly according to FIG. 3 as seen from the top and

FIG. 5 is illustrative of a cross-section A-A through a flow channel according to FIG. 4.

### DETAILED DESCRIPTION

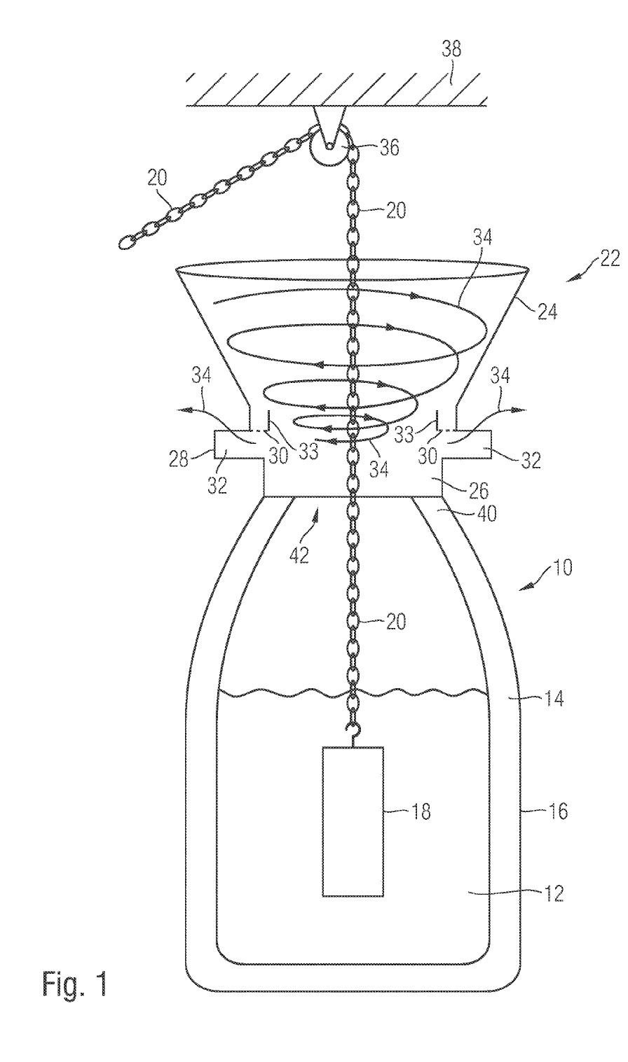

In FIG. 1 a cryopreservation device 10 is schematically illustrated which is equipped with a recovery assembly 22. The cryopreservation device 10 comprises a sample container 16, e.g. typically comprising a Dewar vessel featuring an access opening 42 at its upper end. The container 16 comprises a Dewar wall structure 14 which is thermally insulated and/or which made of non-thermoconducting material. In its interior, the container 16 accommodates an amount of a liquid cooling agent 12, typically liquid nitrogen.

A specimen, e.g. a cryosample 18 is to be stored in the interior of the container 16. It is typically completely immersed in the liquid agent 12. Towards its distal end, hence towards the top of the container 12, the container comprises a radially inwardly extending neck portion 40 that serves to engage with a lower support 26 of the recovery assembly 22. The recovery assembly 22 comprises a cone-shaped funnel portion 24, which by means of the support 26 can be releasably fixed and engaged with the neck portion 40 of the container 16. The funnel portion 24 is hollow and comprises an inner sidewall converging towards the proximal direction, hence downwardly.

Furthermore, the recovery assembly 22 comprises a flow channel 32 arranged downstream and below of the cone-shaped funnel portion 24. The flow channel 32 extends tangentially and/or circumferentially around the outer circumference of the recovery assembly 22. In a transitional area between the flow channel 32 and the cone-shaped funnel portion 24 there is further provided a filter 30 or a sieve operable to retain and to collect particulate material that may be washed down or that may rinse down the cone-shaped inner wall structure of the funnel portion 24.

Radially inwardly, the filter 30 is delimited by an axially upwardly extending wall section which is operable to prevent that the cooling agent 12 simply flows radially and horizontally across the filter 30. Hence, the radially inwardly and upwardly extending wall section 33 forms a kind of annular channel with the radially outwardly located lower end of the funnel portion 24.

The at least one flow channel 32 is to be connected with e.g. a suction blower (not illustrated) by way of which a helically converging stream of protective gas 34 can be generated. The downwardly converging funnel assembly 24 supports development of a spirally revolving gas stream 34, e.g. a cyclone type gas stream. In this way, evaporating cooling agent escaping through the access opening 42 of the container 16 may be accelerated and slaved by the protective gas stream 34. Due to centrifugal forces, liquid particles of the cooling agent, such like aerosol particles or small drops may be accelerated accordingly and may hit the inside-facing wall of the cone-shaped funnel portion 24. In this way, the funnel portion 24 serves to accumulate and to collect cooling agent which may otherwise have left the sample container 16.

The flow channel 32 also extends radially outwardly from the funnel portion 24 and therefore forms a flange 28, which allows for a better gripping and handling of the recovery assembly 22, especially when mounting and dismounting to and from the container 16.

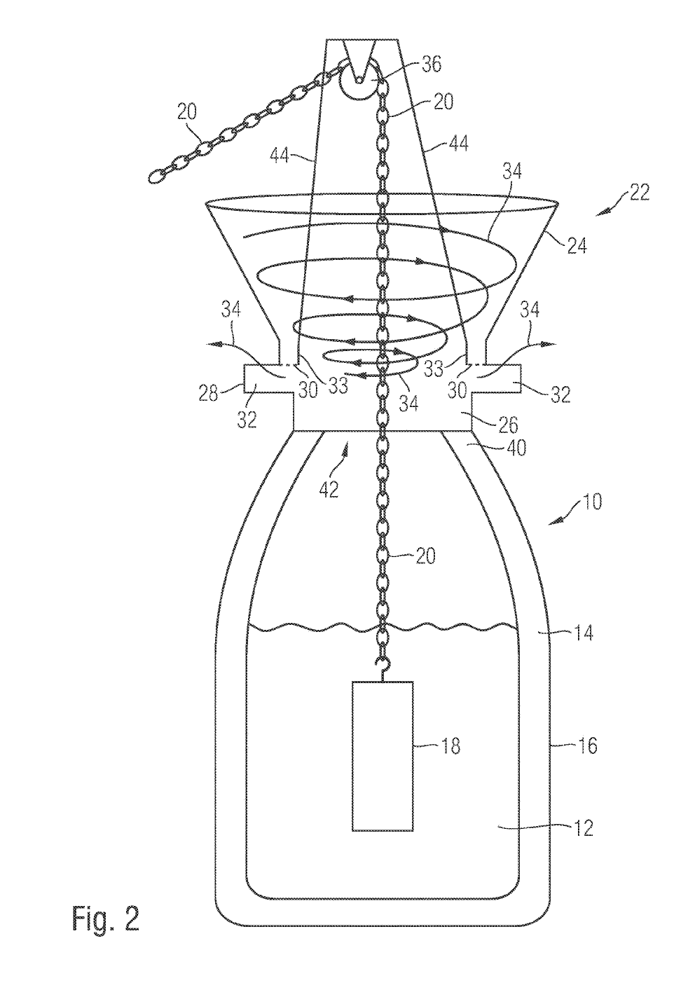

For lifting the specimen 18 immersed in the cooling agent 12 an extraction assembly is provided, e.g. comprising a pulley 36 that serves as a deflection wheel for a chain 20 or for a comparable flexible strap. As illustrated in FIGS. 1 and 2, the specimen or specimen holder 18 may be provided with some kind of a gripping means, e.g. in form of a hook at its upper end allowing to grip and to lift the specimen 18 out of the cooling agent 12. As indicated in FIG. 1, the pulley 36 is mounted on a ceiling 38. By exertion of a lateral, sideward or even downward directed tensile load to the other free end of the chain 20, the specimen or specimen holder 18 can be lifted and can be raised above a level of an upper end or upper rim of the recovery assembly 22.

In the course of lifting or raising the specimen 18 through the access opening 42 and further through the funnel portion 24, excess cooling agent 12 which may drip or rinse down from the lifted specimen holder 18 may be easily collected and fed back into the interior of the sample container 16, especially when the specimen holder 18 is tilted or kept in an inclined orientation compared to the orientation as illustrated in FIGS. 1 and 2.

In the embodiment according to FIG. 2, the extraction assembly is provided as a part of the recovery assembly 22. There, at least one, preferably two or three circumferentially distributed pillars 44 extend from the wall section 33 upwardly in order to provide a support for the pulley 36. In this embodiment, the recovery assembly is integrally formed or is at least releasably connectable with the recovery assembly 22. When mounting the recovery assembly 22 with its support 26 on a sample container 16, the extraction assembly is already in a configuration and position in which it is ready to use. Hence, it is not required to adjust and to position the extraction assembly relative to the recovery assembly 22 and/or to the sample container 16, as it may be the case with the embodiment according to FIG. 1.

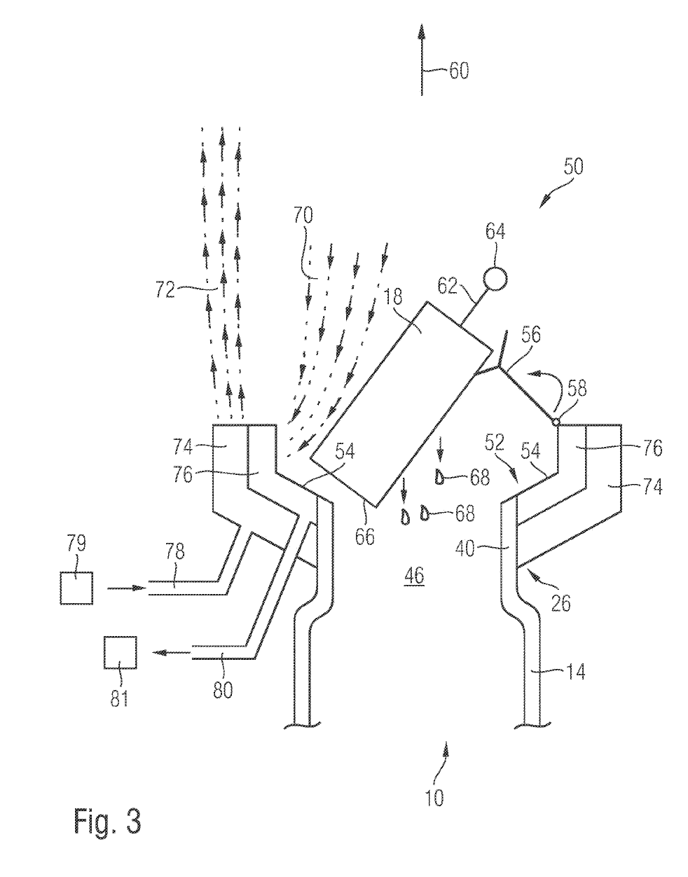

In FIG. 3, another embodiment is illustrated, wherein the recovery assembly 50 also comprises a funnel portion 52 to be arranged with a support 26 to a neck portion 40 of a sample container 16. Independent of the extraction assembly, as for instance illustrated in FIG. 1 and FIG. 2, the recovery assembly 50 according to FIG. 3 comprises a further support 56 pivotally arranged by means of a hinge 58 at an upper end of the funnel portion 52.

As further illustrated in FIG. 3, the further support 56 may be folded to extend at least partially radially inwardly in order to support and to hold the specimen holder 18 in an inclined orientation. It is here of particular benefit, when a bottom portion 66 of the specimen holder 18 can be supported by an obliquely opposite and slanted inner sidewall portion 54 of the funnel portion 52. Hence, the specimen holder 18 can be positioned with its bottom portion 66 on said slanted inner sidewall portion 54 and can be kept in a stable and inclined orientation when leaned against the radially inwardly pivoted further support 56.

As further illustrated in FIG. 3, the specimen holder may be readily provided with rod 62 located at its upper end that may terminate with a handle 64 by way of which the specimen holder 18 can be raised and lifted. In the inclined orientation as illustrated in FIG. 3, excess liquid cooling agent may drop down in form of drops 68 through the orifice 46 and back into the sample container 16.

Independent of the configuration of the further support 56 the embodiment according to FIG. 3 additionally illustrates two flow channels 74, 76 for generating mutually counter-directed and radially separated first and second protective gas streams 70, 72. The radially outwardly located second flow channel 74 is preferably open towards the distal direction 60 in order to provide an axially directed and annular shaped protective gas stream 72. The first and radially inwardly located flow channel 76 comprises another slit located at an upper distal end of the funnel portion 52 but being preferably open towards the radially inwardly-directed sidewall portion thereof. The first flow channel 76 is hence adapted to suck a first protective gas stream 70 in proximal axial direction, hence towards the sample container 16.

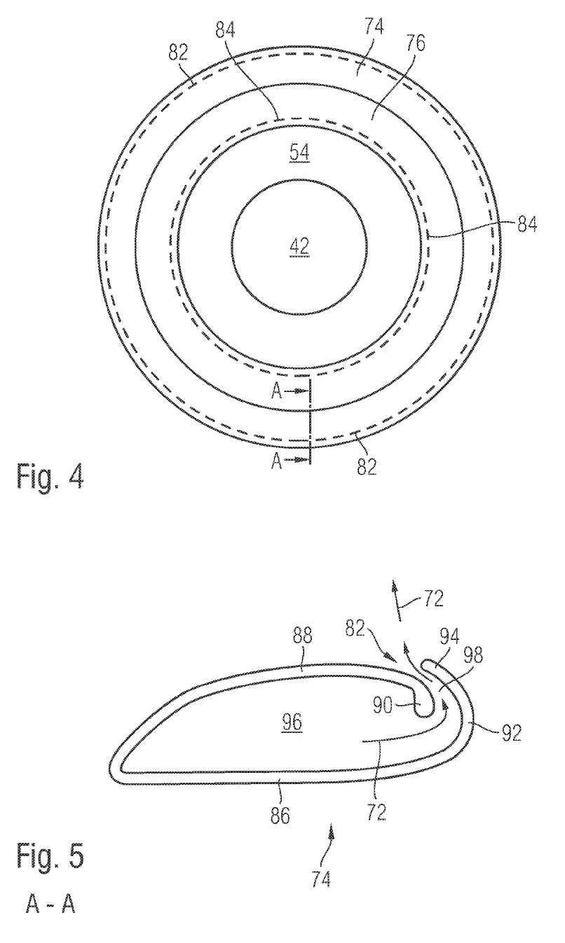

As further indicated in FIG. 4, first and second flow channels 76, 74 are arranged in a nested configuration. Hence, the first flow channel 76 is completely surrounded and encircled by the second flow channel 74. Both flow channels 74, 76 are of substantially annular shape and are each adapted to generate an annular shaped substantially axially oriented stream of protective gas 70, 72.

As further illustrated in FIG. 3, the first flow channel 76 is in fluid or in flow communication with a suction blower 81 by means of a first duct 80. Accordingly, also the second flow channel 74 is in flow connection with a blower 79, preferably with a warm air blower by means of a second duct 78.

The counter-propagating streams of protective gas or protective air 70, 72 are particularly adapted to provide a kind of an air curtain for the recovery assembly 50.

In FIGS. 4 and 5, the structure of first and second flow channels 76, 74 is shown in more detail. While the first flow channel 76 comprises a radially inwardly located and/or radially inwardly directed outlet structure 84, the other, hence the second flow channel 74 comprises a radially outwardly located and/or axially outwardly oriented outlet structure 82. This way, radial separation of respective outlet structures 82, 84 of second and first flow channels 74, 76 can be substantially maximized, which is beneficial for the efficiency of the air curtain.

In the cross-section according to FIG. 5 an internal structure of e.g. the second flow channel 74 is schematically illustrated. The air from the blower 79 may be fed into the interior 96 of the annular-shaped flow channel 74. The supported air may then predominately follow the general structure of the flow channel and may therefore stream in annular, hence tangential direction, perpendicular to the cross-section according to FIG. 5.

Since the flow channel 74 is circumferentially closed, the supported air may only escape from the flow channel 74 by the outlet structure 82 which is provided between a radially inwardly extending lobe portion 90 and an outwardly overlapping section 94 of respective profile portions of the flow channel 74.

As illustrated in FIG. 5, the flow channel 74 comprises a bottom profile section 86, which extends in a curved manner into an upper profile section 88. An upper right end of the profile section 88 then extends into a radially inwardly, hence radially downwardly extending lobe portion 90. The opposite end of the bottom profile section 86 extends into an upwardly directed curved section 92, which at its free end forms an overlapping section 94 substantially overlapping with the lobe portion 90 of the upper profile section 88.

This way, a tapered and cone-shaped portion 98 of the interior 96 of the flow channel 74 can be generated, by way of which the air supplied to the interior 96 of the flow channel 74 can be accelerated and precisely directed in axial and distal direction 60.

The same or a corresponding internal structure is also conceivable for the first flow channel 76.

1-14. (canceled)

15. A recovery assembly for a cryopreservation device, the recovery assembly comprises:
a support for mounting the recovery assembly to an access opening of a cryopreservation container to be at least partially filled with the cooling agent,
at least one flow channel to form at least one protective gas stream to reduce escapement of the cooling agent from the container.

16. The recovery assembly according to claim 15, further comprising at least one cone-shaped funnel portion converging towards the support.

17. The recovery assembly according to claim 16, further comprising a filter penetrable by the cooling agent and being arranged downstream of the funnel portion.

18. The recovery assembly according to claim 15, further comprising an extraction assembly at least for extracting a specimen from the container through the access opening.

19. The recovery assembly according to claim 18, wherein the extraction assembly comprises at least one pillar extending through the funnel portion to support a pulling device located above an upper end of the funnel portion.

20. The recovery assembly according to claim 18, wherein the extraction assembly comprises a further support extending from an upper end of the funnel portion obliquely opposite to a slanted inner side wall portion of the funnel portion for supporting a specimen holder in an inclined orientation above an orifice of the support.

21. The recovery assembly according to claim 16, wherein the flow channel is in fluid communication with an inside facing wall of the funnel portion.

22. The recovery assembly according to claim 15, wherein the flow channel extends in tangential direction around the circumference of a converged lower end of the funnel portion to generate a cyclone-like protective gas stream inside the funnel portion.

23. The recovery assembly according to claim 15, wherein the at least one flow channel extends around an upper distal end of the funnel portion.

24. The recovery assembly according to claim 23, wherein the at least one flow channel comprises at least one slit-like outlet extending in an upper distal direction or extending radially inwardly for generating a substantially axially directed protective gas stream.

25. The recovery assembly according to claim 23, comprising a first flow channel radially enclosed by a second flow channel for generating mutually counter-directed and radially separated first and second protective gas streams.

26. The recovery assembly according to claim 23, wherein the first flow channel is in flow communication with a suction blower and wherein the second flow channel is in flow communication with a warm air blower.

27. A cryopreservation device for storing of at least one specimen, the device comprising:
a container to accommodate a liquid cooling agent wherein said container comprises an access opening at a distal upper end, and
a recovery assembly according to claim 15, wherein the recovery assembly is mounted on the access opening via its support.

28. The cryopreservation device according to claim 27, wherein the recovery assembly is removably mounted on the access opening.
